(19) United States
(12) Patent Application Publication
(10) Pub. No.: US 2008/0187231 A1
(43) Pub. Date: Aug. 7, 2008

(54) Summarization of Audio and/or Visual Data

(75) Inventors: Mauro Barbieri, Eindhoven (NL); Nevenka Dimitrova, Pelham Manor, NY (US); Lalitha Agnihotri, Tarrytown, NY (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/817,798

(22) PCT Filed: Mar. 3, 2006
(86) PCT No.: PCT/IB06/50668

§ 371 Date: Sep. 5, 2007

(30) Foreign Application Priority Data
Mar. 10, 2005 (EP) 05101853.9

(51) Int. Cl. G06K 9/46

(52) U.S. Cl. 382/225

(57) ABSTRACT

Summarization of audio and/or visual data based on clustering of object type features is disclosed. Summaries of video, audio and/or audiovisual data may be provided without any need of knowledge about the true identity of the objects that are present in the data. In one embodiment of the invention are video summaries of movies provided. The summarization comprising the steps of inputting audio and/or visual data, locating an object in a frame of the data, such as locating a face of an actor, extracting type features of the located object in the frame. The extraction of type features is done for a plurality of frames and similar type features are grouped together in individual clusters, each cluster being linked to an identity of the object. After the processing of the video content, the largest clusters correspond to the most important persons in the video.

The invention relates to summarization of audio and/or visual data, and in particular to summarization of audio and/or visual data based on clustering of type features for an object present in the audio and/or visual data.

Automatic summarization of audio and/or visual data aims at efficient representations of audio and/or visual data for facilitating browsing, searching, and more generically—managing of content. Automatic generated summaries can support users in searching and navigating through large data archives, e.g. for taking decisions more efficiently regarding acquiring, moving, deleting, etc. content.

Automatic generation of e.g. video previews and video summaries requires locating video segments with main actors or persons. Current systems use face and voice recognition technologies to identify the persons appearing in the video.

The published patent application US 2003/0123712 discloses a method for providing name-face/voice-role association by using face recognition and voice identification technologies so that a user can query information by entry of role-name, etc.

The prior art systems require an a priori knowledge of the persons that appear in the video, e.g., in the form of a database of features associated to persons' names. However, a system may not be able to find the name or the role for the respective face or voice model. Creating and maintaining a database is a very expensive and difficult task for generic video (e.g. TV content and home video movies). Furthermore, such a database will inevitably be very big resulting in slow access during the recognition phase. For home videos such a database will require continuous and tedious updates from the user in order not to become obsolete, every new face has to be identified and labeled properly.

The inventors of the present invention have appreciated that an improved way of summarization of audio and/or visual data is of benefit, and have in consequence devised the present invention.

The present invention seeks to provide an improved way of summarization of audio and/or visual data by providing a system which can work independently of a priory knowledge of who or what is in audio and/or visual data. Preferably, the invention alleviates, mitigates or eliminates one or more of the above or other disadvantages singly or in any combination.

Accordingly there is provided, in a first aspect, a method of summarization of audio and/or visual data, the method comprising the steps of:

inputting a set of audio and/or visual data, each member of the set being a frame of audio and/or visual data,

locating an object in a given frame of the audio and/or visual data set,

extracting type features of the located object in the frame,

wherein the extraction of type features is done for a plurality of frames, and wherein similar type features are grouped together in individual clusters, each cluster being linked with an identity of the object.

Audio and/or visual data includes audio data, visual data and audio-visual data, i.e. audio-only data is included (sound data, voice data, etc.), visual-only data is included (streamed images, images, photos, still frames, etc.) as well as data comprising both audio and visual data (movie data, etc.). A frame may be an audio frame, i.e. a sound frame, or an image frame.

The term summarization of audio and/or visual data is to be construed broadly, and should not be construed to pose any limitation on the form of the summary, any suitable form of summary within the scope of the invention can be envisioned.

In the present invention is the summarization based on the number of similar type features grouped together in individual clusters. Type features are features characteristic of the object in question, such as features which can be derived from the audio and/or visual data reflecting the identity of the object. The type features may be extracted by means of a mathematical routine. The grouping of type features in clusters facilitates the identification of and/or ranking of important objects in the set of data solely on the basis of what can be derived from the data itself, and not relying upon alternative sources. For example, in connection with video summarization, the present invention does not determined the true identity of the persons in analyzed frames, the system uses clusters of type features, and assessing the relative importance of the persons according to how large their clusters are, i.e. the number of type features that has been detected for each object in the data, or more specifically how many times the object has appeared in the visual data. This approach is applicable for any type of audio and/or video data without the need for any a priori knowledge (e.g. access to a database of known features).

It is an advantage to be able to make summarization in audio and/or visual data without using a priory knowledge about the true identity of objects present in the data since a way of summarization of data is provided where it may be avoided to consult a database for recognition of an object. For example in a situation where such a database does not exists, or even if it exists, e.g. for generic video (e.g. TV content or home movies) creating and maintaining the database is a very expensive and difficult task. Furthermore the database will inevitably be very big resulting in extremely slow access during the recognition phase. For home videos such a database will require continuous and tedious updates from the user since every new face has to be identified and labeled properly. A further advantage relates to that the method is robust with respect to false detection of an object, since the method relies on statistical sampling of objects.

The optional features as defined in claim 2 have the advantage that by having the set of audio and/or visual data is in the form of a data stream, existing audio and/or visual systems may easily be adapted to provide the functionality of the present invention, since the data format of most consumer electronics, such ad CD-players, DVD-players, etc., is in the form of streamed data.

The optional features as defined in claim 3 have the advantage that a number of object detecting methods exists, thus providing a robust method of summarization since the object detection part is well controlled.

The optional features as defined in claim 4 have the advantage that by providing a method for summarization based on face features, a versatile method of summarization is provided, since summarization of visual data based on face features facilitates a method for locating important persons in a movie or locating persons in photos.

The optional features as defined in claim 5 have the advantage that by providing a method for summarization based on sound, a versatile method of summarization is provided, since video summarization based on sound features, typically voice features, is facilitated, as well as the summarization of audio data itself.

By providing both the features of claim 4 and claim 5, an even more versatile summarization method may be provided since an elaborate summarization method supporting summarization based on any combination of audio and visual data is rendered possible, such as a summarization method based on face detection and/or voice detection.

The optional features as defined in claim 6 have the advantage that an endless number of data structures suitable for presentation to a user, i.e. summary types, can be provided adapted to the desires and needs of specific user groups or users.

The optional features as defined in claim 7 have the advantage that the number of type features in an individual cluster typically correlates with the importance of the object in question, a direct means of conveying this information to a user is thereby provided.

The optional features as defined in claim 8 have the advantage that even though the object clustering works independently of a priori known data, a priory knowledge may still used in combination with the cluster data, so as to provide a more complete summary of the data.

The optional features as defined in claim 9 have the advantage that a faster routine may be provided.

The optional features as defined in claim 10 have the advantage that by grouping audio and visual data separately a more versatile method may be provided, since audio and visual data in audiovisual data are not necessarily directly correlated, a method that works independently of any specific correlation of audio and visual data may thereby be provided.

The optional features as defined in claim 11 have the advantage that in a situation where a positive correlation between objects in audio and visual data is found, this may be taken into account, so as to provide a more detailed summary.

According to a second aspect of the invention, is provided a system for summarization of audio and/or visual data, the system comprising:

an inputting section for inputting a set of audio and/or visual data, each member of the set being a frame of audio and/or visual data,

an object locating section for locating an object in a given frame of the audio and/or visual data set,

an extracting section for extracting type features of the located object in the frame,

wherein the extraction of type features is done for a plurality of frames, and wherein similar type features are grouped together in individual clusters, each cluster being linked with an identity of the object.

The system may be a stand-alone box of the consumer electronic type, where the inputting section, e.g. may be coupled to an outputting section of another audio and/or visual apparatus, so that the functionality of the present invention may be provided to an apparatus not supporting this functionality. Alternatively may the system be an add-on module for adding the functionality of the present invention to an existing apparatus. Such as adding the functionality to existing DVD-players, BD-players, etc. Apparatuses may also be born with the functionality, the invention therefore also relates to a CD-player, a DVD-player, a BD-player, etc. provided with the functionality of the present invention. The object locating section and extraction section may be implemented in electronic circuitry, in software, in hardware, in firmware or in any suitable way of implementing such functionality. The implementation may be done using general purpose computing means or may be done using dedicated means present either as a part of the system, or as a part to which the system may gain access.

According to a third aspect of the present invention is provided a computer readable code for implementing the method according to the first aspect of the invention. The computer readable code may also be used in connection with controlling the system according to the second aspect of the present invention. In general may the various aspects of the invention may be combined and coupled in any way possible within the scope of the invention.

These and other aspects, features and/or advantages of the invention will be apparent from and elucidated with reference to the embodiments described hereinafter.

Embodiments of the invention will be described, by way of example only, with reference to the drawings, in which:

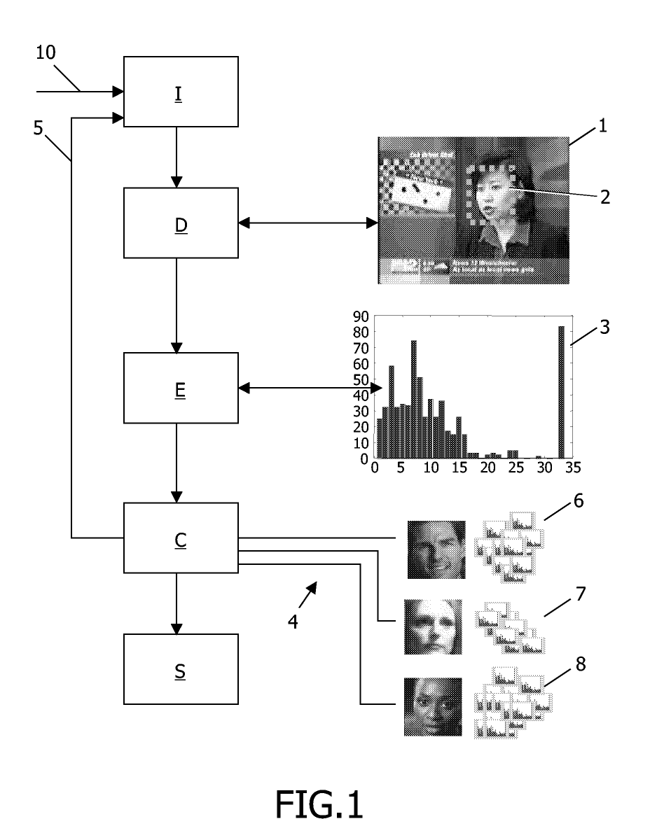

FIG. 1 schematically illustrates a flow diagram of an embodiment of the present invention,

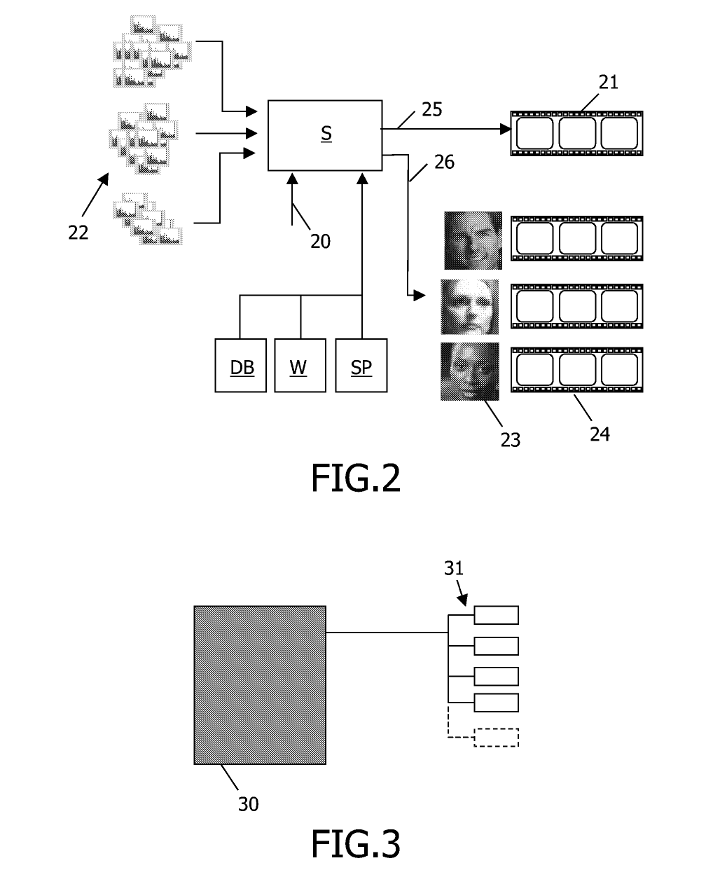

FIG. 2 schematically illustrates two embodiments of transforming the grouped clusters into a video summary/summaries, and

FIG. 3 schematically illustrates summarization of photo collections.

An embodiment of the invention is described for a video summarization system that locates segments in the video content representing the main (lead) actors and characters. Elements of this embodiment are schematically described in FIG. 1 and FIG. 2. The object detection is however not limited to face detection, any type of object may be detected, e.g. a voice, a sound, a car, a telephone, a cartoon character, etc. and the summary may be based on such objects.

A set of visual data is inputted 10 at a first stage I, i.e. an input stage. The set of visual data may be a stream of video frames from a movie. A given frame 1 of the video stream may be analyzed by a face detector D. The face detector may locate an object 2 in the frame, which in this case is a face. The face detector will provide the located face to a face feature extractor E for extraction of type features 3. The type features are here exemplified by a vector quantization histogram which is known in the art (see e.g. Kotani et al., “Face Recognition Using Vector Quantization Histogram Method”, Proc. of IEEE ICIP, pp. 105-108, September 2002.). Such a histogram uniquely characterizes a face with a high degree of certainty. The type features of a given face (object) may thus be provided irrespectively of whether the true identity of the face is known. A this stage may an arbitrary identity be given to the face, e.g. face#1 (or generally face#i, i being a label number). The type features of the face is provided to the clustering stage C, where the type features are grouped 4 together according to the similarity of the type features. If similar type features have already been found in an earlier frame, i.e. in this case, if a similar vector quantization histogram has already been found in an earlier frame, the features are associated to this group 6-8, and if the type features are new, a new group is created. For the clustering, known algorithms such as k-means, GLA (Generalized-Lloyd Algorithm) or SOM (Self Organizing Maps) can be used. The identity of the object of a group may be linked to a specific object in the group, for example may a group of images be linked to one of the images or a group of sounds may be linked to one of the sounds.

In order to get a sufficient amount of data to gain insight into who are the most important persons in the film, a new frame may then be analyzed 5 until a plurality of frames have been analyzed with respect to extraction of type features, e.g. until a sufficient amount of objects have been grouped together, so that after the processing of the video content, the largest clusters correspond to the most important persons in the video. The specific amount of frames needed may depend on different factors and may be a parameter of a system, e.g. a user or system adjustable parameter so as to determine the number of frames to be analyzed e.g. in a trade-off between thoroughness of the analysis and the time spend on the analysis. The parameter may also dependent upon the nature of audio and/or visual data, or on other factors.

All frames of the movie may be analyzed, however it may be necessary or desired only to analyze a subset of frames from the movie in order to find the cluster, which has the most faces and also consistently has the largest sizes (potentially lead actor clusters). Usually, the lead actor is given a lot of screen time and is present throughout the duration of the movie. Even if only one frame every minute is analyzed, the chances are overwhelming that an important actor will be present in a large number of frames from the number of frames that are selected for the movie (120 for a 2 hour film). Also, since, they are important to the movie, close up shots are seen much more than for those of any other supporting actors who may have a few pockets of important scenes in the movie. The same arguments apply to the robustness of the method with respect to false detections of a face, since for a strong method like the Vector Quantization Histogram Method, or other methods where unique type features are assigned to a face with a high degree of certainty, important persons in a movie will still be found since it is not crucial if not all occurrences are counted, as long as enough frames are analyzed in order to get a statistical significant number of true detections.

The grouped clusters may be transformed in summary generator S into a data structure which is suitable for presentation to a user. An endless number of possibilities exist for transforming information of the grouped clusters, such information includes but is not limited the number of groups, the number of type features in a group, the face (or object) associated with a group, etc.

FIG. 2 illustrates two embodiments of transforming the grouped clusters 22 into a data structure which is suitable for presentation to a user, i.e. for transforming the grouped clusters into a summary 25, or a structure of summaries 26.

The summary generator S may consult a number of rules and settings 20, e.g. rules and settings dictating the type of summary to be generated. The rules may be algorithms for selecting video data, and the settings may include user settings, such as length of summary, number of cluster to consider, e.g. consider only 3 must import clusters (as illustrated here), 5 most important clusters, etc.

A single video summary 21 may be created. A user may e.g. set that the length of the summary and that the summary should include the 3 most import actors. Rules may then e.g. dictate that half of the summary should include the actor associated with the cluster comprising the most type features and how to select the relevant video sequences of this actor, that one quarter of the summary should include the actor associated with the cluster comprising the second most type features, and that the remaining quarter should include the actor associated with the cluster comprising the third most type features.

A video summary structure showing a list 23 of the most important actors in the film may also be created, the list being ordered according to the number of type features in the clusters. A user setting may determine the number of actors to be included in the list. Each item in the list may be associated with an image 23 of the face of the actor. By selecting an item from the list, may the user be presented with a summary 24 including only, or primarily scenes where the actor in question is present.

In another embodiment is the audio track also considered. The audio signal can be automatically classified into speech/non-speech. From the speech segments voice features such as Mel-Frequency Cepstral Coefficients (MFCC) can be extracted and clustered with standard clustering techniques (e.g. k-means, SOM, etc.).

Audio objects can be considered together with visual objects, or separately from, e.g. in connection with sound summaries.

In a situation where face features and voice features are considered together e.g. to include both in a summary, the clustering may be done separately. Simply linking face features with voice features may not work because there are no guarantees that a voice in the audio track corresponds to the person whose face is shown in the video. Furthermore there might be more faces shown in a video frame and only one actually speaking. Alternatively, face-speech matching can be used to find out who is talking in order to link the video and audio features. The summarization system can then choose the segments with face and voice features belonging respectively to the main face and voice clusters. The segment selection algorithm prioritizes the segments within each cluster based on overall face/voice presence.

In yet another embodiment is a priory known information included in the analysis. The identity of a type may be correlated to a database DB of known objects and if a match is found between the identity of the cluster and an identity of a known object, the identity of the known object may be included in the summary.

For example, may the analysis of the dialog from the script/screenplay of a movie be added. For a given movie title, the system may perform an Internet search W and find the screenplay SP. From the screenplay can the relative dialog length and the rank order the characters be calculated. Based on screenplay-audio alignment can the labels for each of the audio (speaker) clusters be obtained. The lead actor choice can be based on combining information from both ranked lists: audio-based and screenplay-based. This may be very helpful in movies where narrators occupy screen time but are not in the movie themselves.

In an even further embodiment can the invention be applied to the summarization of photo collections (e.g. selection of a representative subset of a photo collection for browsing or automatic creation of photo slideshows), this is schematically illustrated in FIG. 3. Many users of digital cameras may produce a vast amount of photos 30 stored in the order of when the image was taken. The present invention may be used in order to facilitate handling of such collections. A summary may e.g. be created based on who is shown in the photos, a data structure 31 may e.g. be provided to the user, where each item corresponds to a person in the photo. By selecting the item, all photos of this person may be viewed, a slide show of a selection of the photos may be presented, etc.

Further, may the invention be applied to video summarization systems for Personal Video Recorders, video archives, (automatic) video-editing systems, and video on demand systems, digital video libraries.

Although the present invention has been described in connection with preferred embodiments, it is not intended to be limited to the specific form set forth herein. Rather, the scope of the present invention is limited only by the accompanying claims.

In this section, certain specific details of the disclosed embodiment such as specific uses, types of object, form of summaries etc., are set forth for purposes of explanation rather than limitation, so as to provide a clear and thorough understanding of the present invention. However, it should be understood readily by those skilled in this art, that the present invention may be practiced in other embodiments which do not conform exactly to the details set forth herein, without departing significantly from the spirit and scope of this disclosure. Further, in this context, and for the purposes of brevity and clarity, detailed descriptions of well-known apparatus, circuits and methodology have been omitted so as to avoid unnecessary detail and possible confusion.

Reference signs are included in the claims, however the inclusion of the reference signs is only for clarity reasons and should not be construed as limiting the scope of the claims.

1. Method of summarization of audio and/or visual data, the method comprising the steps of:
inputting (10) a set of audio and/or visual data, each member of the set being a frame (1) of audio and/or visual data,
locating (D) an object (2) in a given frame of the audio and/or visual data set,
extracting (E) type features (3) of the located object in the frame,
wherein the extraction of type features is done for a plurality of frames, and wherein similar type features are grouped (4) together in individual clusters (6-8), each cluster being linked with an identity of the object.

2. Method according claim 1, wherein the set of audio and/or visual data is a stream of audio and/or visual data.

3. Method according to claim 1, wherein the data is a set of visual data, and wherein the object in a frame (1) is a graphical object and wherein the locating (D) of the type is done by means of an object detector.

4. Method according to claim 3, wherein the object in a frame is a face (2) of a person and wherein the locating (D) of the object is done by means of a face detector.

5. Method according to claim 1, wherein the data is a set of audio data, and wherein the frame is an audio frame and wherein the locating of the object is done by means of a sound detector.

6. Method according to claim 1, wherein the grouped clusters (22) are transformed (20) into a data structure (25, 26) suitable for presentation to a user.

7. Method according to claim 6, wherein the data structure reflects the number of type features in the individual cluster.

8. Method according to claim 6, wherein the identity of the type is correlated to a database (DB) of known objects and wherein if a match is found between the identity of the type and an identity of a known object, the identity of the known object is reflected in the data structure.

9. Method according to claim 2, wherein the plurality of frames is a subset of the stream of audio and/or visual data.

10. Method according to claim 2, wherein the stream of audio and/or visual data is audiovisual data including both visual and audio data, and wherein the visual and audio data are clustered separately resulting in visual type features grouped together in individual visual clusters and audio type features grouped together in individual audio clusters.

11. Method according to claim 10, wherein the identity of the visual clusters are correlated to the identity of the audio clusters, and wherein if a positive correlation is found between the identity of the visual and audio cluster, the visual and the audio clusters are linked together.

12. A system for summarization of audio and/or visual data, the system comprising:
an inputting section (I) for inputting a set of audio and/or visual data, each member of the set being a frame of audio and/or visual data,
an object locating section (D) for locating an object (2) in a given frame (1) of the audio and/or visual data set,
an extracting section (E) for extracting type features (3) of the located object in the frame,
wherein the extraction of type features is done for a plurality of frames, and wherein similar type features are grouped (4) together in individual clusters (6-8), each cluster being linked with an identity of the object.

13. Computer readable code for implementing the method of claim 1.

14. Use of clustering of type features of objects in audio and/or visual data for summarization of audio and/or visual data.
